(19) United States
(12) Patent Application Publication
(10) Pub. No.: US 2024/0068448 A1
(43) Pub. Date: Feb. 29, 2024

(54) DISPLACEMENT OF A HORIZONTAL PILE

(71) Applicant: MacGregor Norway AS, Kristiansand S (NO)

(72) Inventor: Prateek Sadhana, Bjorbekk (NO)

(73) Assignee: MacGregor Norway AS, Kristiansand S (NO)

(21) Appl. No.: 18/270,653

(22) PCT Filed: Dec. 21, 2021
(86) PCT No.: PCT/EP2021/087123

§ 371 Date: Jun. 30, 2023

(30) Foreign Application Priority Data
Dec. 30, 2020 (NO) 20201444

(51) Int. Cl. F03D 13/10; B63B 25/28; F03D 13/40

(52) U.S. Cl. CPC F03D 13/126; B63B 25/28; F03D 13/112; F03D 13/40; B63B 27/19

(57) ABSTRACT

A pile displacement system includes a first subsystem, and a second subsystem arranged adjacent to the first subsystem along a longitudinal axis of the monopile. Each of the first and the second subsystems includes a height adjustable support, and a pile support unit arranged on the height adjustable support such that the pile support unit is movable along the monopile's longitudinal axis. A method for displacing a horizontally oriented monopile for an off-shore wind turbine parallel to a base floor by use of the pile displacement system includes arranging the monopile onto the monopile support units of the first and second subsystems; lowering the height adjustable support of at least the first subsystem towards the base floor until the weight of the monopile is transferred from at least the first subsystem to an external support structure aligned along the monopile's longitudinal axis, adjacent to the first subsystem; moving the pile support unit of the first subsystem a distance in direction away from the external support structure; raising the height adjustable support of the first subsystem away from the base floor until the weight of the monopile is transferred from the external support structure to the first subsystem; and moving the pile support units of the first and the second subsystems a distance in direction towards the external support structure.

### FIELD OF THE INVENTION

The present invention relates to a method for displacing a horizontal oriented pile, in particular a tubular wind turbine monopile, and a pile displacement system for use in such a method.

### BACKGROUND AND PRIOR ART

Installation of wind turbine monopiles (MP), i.e. fundaments for offshore wind turbines, in sea, has been performed for decades. See for example patent publication JP 2001/1207948.

As exemplified in patent publication WO 2018/117846 A1, the MPs are normally transported horizontally on a deck of a transport vessel to their installation site. When the vessel is in place and stabilized, each MP is lifted to a vertical position and then lowered down until contact with the seabed, typically by aid of a heavy lift crane and a dedicated up-ending tool. When the respective MP is positioned at the correct position, it is typically hammered into the seabed by use of a hammering tool.

Compared to most cargos and tools handled on transport vessels, piles used as fundaments for wind turbines are large and heavy and therefore challenging to maneuver on deck from their parking positions.

Several systems and methods for maneuvering large elongated objects such as monopiles horizontally on deck have been described previously. For example, patent publication EP3090171B1 describes a method that facilitates pile transportation and reduces the need of crane lifting operations on deck. The piles in this known solution are arranged in dedicated frameworks that cover the circumference of the pile. These frameworks comprise wheels or pinions that allow movements in horizontal directions. See also patent publications WO2014/158025A1, WO2020011681A1, EP3670318A1 and EP3109531A1 for other solutions of horizontal pile displacements.

One disadvantage with these known solutions is that they do not allow pile movements without use of other auxiliary equipment such as heavy lift cranes. In addition to an increase in complexity and operation cost, use of such auxiliary equipment may reduce accuracy as well as an increased need of human interventions. The latter may also involve serious health hazard.

It is therefore an objective of the invention to provide a method and a related system that allows displacement of a pile from its parking position with high degree of accuracy.

Another objective of the invention is to provide a method and a related system that reduces the need of human intervention during such pile displacement, i.e. that allows for a high degree of automation.

### SUMMARY OF THE INVENTION

The present invention is set forth and characterized in the main claims, while the dependent claims describe other characteristics of the invention.

In a first aspect, the invention concerns a method for displacing a horizontally oriented pile parallel to a base floor by use of a pile displacement system. Note that a pile is herein defined as any elongated object such as steel construction beams, monopiles for wind turbines or wind turbine blades.

The pile displacement system comprises a first subsystem and a second subsystem arranged adjacent to each other along a longitudinal axis L of the pile.

Each of the first and the second subsystems comprises a height adjustable support and a pile support unit arranged on the height adjustable support such that the pile support unit is movable along the pile's longitudinal axis L.

The inventive method comprises the following steps:
A. arranging the pile to be handled onto the pile support units of the first and second subsystems such that the pile's longitudinal axis L is oriented parallel to the base floor,
B. lowering the height adjustable support of at least the first subsystem towards the base floor by use of height adjusting means such as hydraulic cylinders until at least part of the weight of the pile has been transferred from the at least first subsystem to an external support structure aligned along the pile's longitudinal axis L, adjacent to the first subsystem,
C. moving the pile support unit of the first subsystem a distance in direction away from the external support structure, the distance being less or equal to a length of the height adjustable support of the first subsystem along the longitudinal axis L,
D. raising the height adjustable support of the first subsystem away from the base floor until the at least part of the weight of the pile is transferred from the external support structure back to the first subsystem and
E. moving the pile support units of the first and the second subsystems a distance in direction towards the external support structure, thereby shifting the position of the pile along its longitudinal axis L more towards the external support structure.

As for step C, the distance in step E is less or equal to a minimum length of the height adjustable supports along the longitudinal axis L.

The pile displacement system is preferably connected to a dedicated control system that allows remote operations of at least the movements in steps B to E.

In an exemplary configuration of the invention, the method further comprises the step of moving the pile displacement system sideways along the base floor in direction perpendicular to the pile's longitudinal axis L. The pile displacement system is in this configuration hence configured to move in two main directions; parallel to L and perpendicular to L.

Using the above configuration, and prior to step A, the method may comprise the steps of lowering the height adjustable supports towards the base floor by use of the height adjusting means such that the highest point of the pile displacement system is lower than a minimum vertical distance from the base floor to a nearby horizontal pile stored on the base floor within a pile parking support, moving the pile displacement system sideways along the base floor towards the horizontal pile by use of sideways transporting means such as rails and/or wheels and sideways aligning the pile displacement system with the pile's longitudinal axis L such that the pile supporting units are located directly below the pile.

Note that the above lowering of the height adjustable supports may be performed simultaneously with the sideways movement. Alternatively, sideways movement may be performed both before and after the step of lowering the supports.

Moreover, the pile parking support may comprise two parking cradles placed at a distance along the longitudinal axis L, wherein the distance is equal or shorter than the total length of the pile. For example, the distance between the cradles may be at least 80% of the pile length.

The method may further comprise the steps of raising the height adjustable supports until step A is completed, i.e. that the pile has been arranged onto the pile support units, and continue raising the height adjustable supports with the full weight of the pile on the pile support units until the lowest point of the pile relative to the base floor is located higher than the highest point of the pile parking support, thereby allowing sideways movements without risking undesired impacts.

After completing step A, and prior to step B, the method may further comprise the step(s) of moving the pile displacement system with the pile sideways towards the external support structure and, if needed, raising the height adjustable supports until the lowest point of the pile relative to the base floor is higher than the highest point of the external support structure to eliminate the risk of undesired impacts.

Note that the raising of the supports may be performed prior to the sideways movements and/or during sideways movements.

Still after step A, but before step B, the method further comprises the step of moving the pile displacement system sideways until the pile's longitudinal axis L is aligned with a vertical center plane of the external support structure. The vertical center plane is oriented parallel to the longitudinal axis L.

The design of the external support structure is preferably mirror symmetric around a vertical center plane, for example a cradle form or a horizontal beam. In this case the vertical center plane is the plane intercepting a midpoint of the external support structure along the horizontal extent perpendicular to the longitudinal axis L. In case the external support structure is not mirror symmetric, the vertical center plane can be defined as the vertical plane intercepting the center of mass of the external support structure. Alternatively, the center of gravity may be used.

In another exemplary configuration of the invention the base floor is a deck constituting part of a vessel suitable for transporting a plurality of wind turbine monopiles between a port and an installation site and the external support structure constitutes part of a pile upending tool configured to tilt one of the plurality of monopiles between a horizontal orientation parallel to the deck and located at least partly within the deck boundaries and a vertical orientation outside the deck boundaries.

The pile upending tool may further comprise an end support at an equal vertical height as the external support structure and arranged such that the external support structure and the end support are aligned along the pile's longitudinal axis L, and wherein steps B to E are repeated until a pile end of the pile located nearest the pile upending tool abuts the end support. The external support structure is hence in this exemplary configuration arranged between the end support and the first subsystem of the pile displacement system.

In a second aspect, the invention concerns a computer-readable medium having stored thereon a computer program comprising instructions to at least partly execute any of the method steps described above. For example, the computer program may control at least the movements B-E by communicating with motors controlling the various movements, and where the extents of the movements/alignments are set due to measurements of one or more installed sensors such as accelerometers.

In a third aspect, the invention concerns a pile displacement system suitable for displacing a pile. As for the first aspect, a pile is herein defined as any elongated object such as steel construction beams or monopiles for wind turbines.

The pile displacement system comprises a first subsystem and a second subsystem arranged adjacent to each other along a principal direction C, wherein each of the first and the second subsystems comprises a height adjustable support and a pile support unit arranged on the height adjustable support such that the pile support unit is movable along the principal direction C, and wherein the pile support unit of the first subsystem is aligned along C with the pile support unit of the second subsystem.

During use, the pile displacement system may be arranged such that an external support structure as described above in connection with the first aspect is situated next to the first subsystems with its vertical center plane aligned along the principal direction C.

Each pile support unit may comprise a concave pile receiving face in order to ensure sufficient horizontal stability of the pile. Such a concave pile receiving face preferably has a radius of curvature equal or near equal to a radius of curvature of the pile to be handled/displaced, for example a radius of curvature between 1 to 3 meters.

Moreover, each of the first and the second subsystems may comprise height adjusting means such as hydraulic cylinders and/or linear actuators for adjusting the height of the height adjustable support relative to a base floor during use. Such height adjusting means are fixed between the height adjustable supports and the base floor/deck.

The pile displacement system may further comprise one or more a pile displacement system bases onto which the height adjustable supports of the first and second subsystems are connected via the height adjusting means. Preferably, a single pile displacement base is used for both the first and the second subsystems. However, one system base for each subsystem may also be envisaged.

The pile displacement system base may be configured such that it is movable sideways along a base floor onto which the system base is supported during use. The direction of the sideways movement is perpendicular to the principal direction C.

The side of the pile displacement system base facing towards the base floor during use may comprise a recess and/or a protrusion for allowing restricted/guided movement on one or more base floor tracks/rails oriented perpendicular to the principal direction C on or within the base floor. Said protrusions may be wheels configured to move on linear rails. Use of low friction sliding bars may also be envisaged.

In addition, or alternatively, the pile displacement system may be moved by use of a rack-and-pinion system comprising circular gears (pinions) connected to linear gear (rack) arranged along the base floor. The circular gears, and the corresponding drive motor driving the circular gears, may be a separate unit located at on the side of the up-ending tool (i.e. along the aft-bow-direction) opposite the locations of the piles.

In particular during displacement of monopiles for wind turbines a preferred embodiment is the use of both a wheel/rail system and a rack-and-pinion-system in order to handle the excessive weights with sufficient accuracy and safety.

Each height adjustable support may comprise a height adjustable support track oriented in the principal direction and each pile supporting unit may comprise a recess and/or a protrusion for allowing restricted/guided movement along the height adjustable support tracks. As for sideways movements of the system base, these pile supporting units may be moved by aid of wheels in addition or alternative to guided tracks.

### BRIEF DESCRIPTION OF THE DRAWINGS

The following drawings depict alternatives of the present invention and are appended to facilitate the understanding of the invention. However, the features disclosed in the drawings are for illustrative purposes only and shall not be interpreted in a limiting sense.

FIG. 1 illustrates in two different perspectives a pile displacement system in accordance with the invention, where FIG. 1A and FIG. 1B shows the pile displacement system with one of two pile supporting cradles in its rightmost and its leftmost position, respectively.

FIG. 2 illustrates an example of a pile supporting cradle, where FIG. 2A shows the pile supporting cradle in a perspective view and FIG. 2B shows a side view of the pile supporting cradle arranged on a support cradle displacement system.

FIG. 3 illustrates a part of a pile displacement system in accordance with the invention, where the system includes a height adjustment device different from the height adjustment device shown in FIG. 1.

FIG. 4 illustrates in perspective a transport vessel containing a plurality of piles in parking positions in dedicated parking cradles on deck, a pile displacement system in accordance with the invention and a pile up-ending tool for tilting the pile from horizontal to vertical orientation relative to the vessel's deck.

FIG. 5 illustrates a cross sectional aft-to-bow view of an installation vessel where a pile up-ending tool has tilted a pile to a vertical orientation relative to the vessel's deck.

FIG. 6 illustrates a first, initial step of an pile displacement process in accordance with the invention, where a pile gripper and an end support of the pile up-ending tool are arranged in a horizontal installation position, and where a pile displacement system in accordance with the invention is arranged directly behind the pile up-ending tool.

FIG. 7 illustrates a second step of the inventive pile displacement process, where the inventive pile displacement system has been displaced sideways from the initial position directly behind the pile up-ending tool to a position directly below the nearest pile parked on the deck.

FIG. 8 illustrates a third step of the inventive pile displacement process, where an upper part of the inventive pile displacement system has been lifted vertically towards the parked pile such that the weight of the pile is transferred from a parking cradle to the pile displacement system.

FIG. 9 illustrates a fourth step of the inventive pile displacement process, where the upper part of the inventive pile displacement system has been further raised to lift the pile higher than the highest point of the parking cradle.

FIG. 10 illustrates a fifth step of the inventive pile displacement process, where the inventive pile displacement system has been displaced horizontally a part of the distance back to the initial position shown in FIG. 6.

FIG. 11 illustrates a sixth step of the inventive pile displacement process, where the upper part of the inventive pile displacement system has been lifted above the highest point of the pile up-ending tool when the pile up-ending tool is in its horizontal installation position.

FIG. 12 illustrates a seventh step of the inventive pile displacement process, where the inventive pile displacement system has been displaced sideways to the initial position directly behind the pile up-ending tool.

FIG. 13 illustrates an eighth step of the inventive pile displacement process, where the upper part of the inventive pile displacement system has been lowered vertically until contact, or near contact, between the pile and an upper support of the pile up-ending tool has been achieved.

FIG. 14 illustrates a ninth step of the inventive pile displacement process, where a part of the inventive pile displacement system nearest the pile up-ending tool has been lowered such that the weight of the pile is transferred to the upper support.

FIG. 15 illustrates a tenth step of the inventive pile displacement process, where a pile supporting cradle arranged on the part of the inventive pile displacement system nearest the pile up-ending tool has been moved away from the upper support.

FIG. 16 illustrates an eleventh step of the inventive pile displacement process, where the part of the inventive pile displacement system nearest the pile up-ending tool has been raised to re-establish supporting contact with the pile.

FIG. 17 illustrates a twelfth step of the inventive pile displacement process, where the pile supporting cradle on the part of the inventive pile displacement system nearest the pile up-ending tool and a second pile supporting cradle on a part of the inventive pile displacement system most distal the pile up-ending tool have been moved a distance towards the pile-ending tool.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

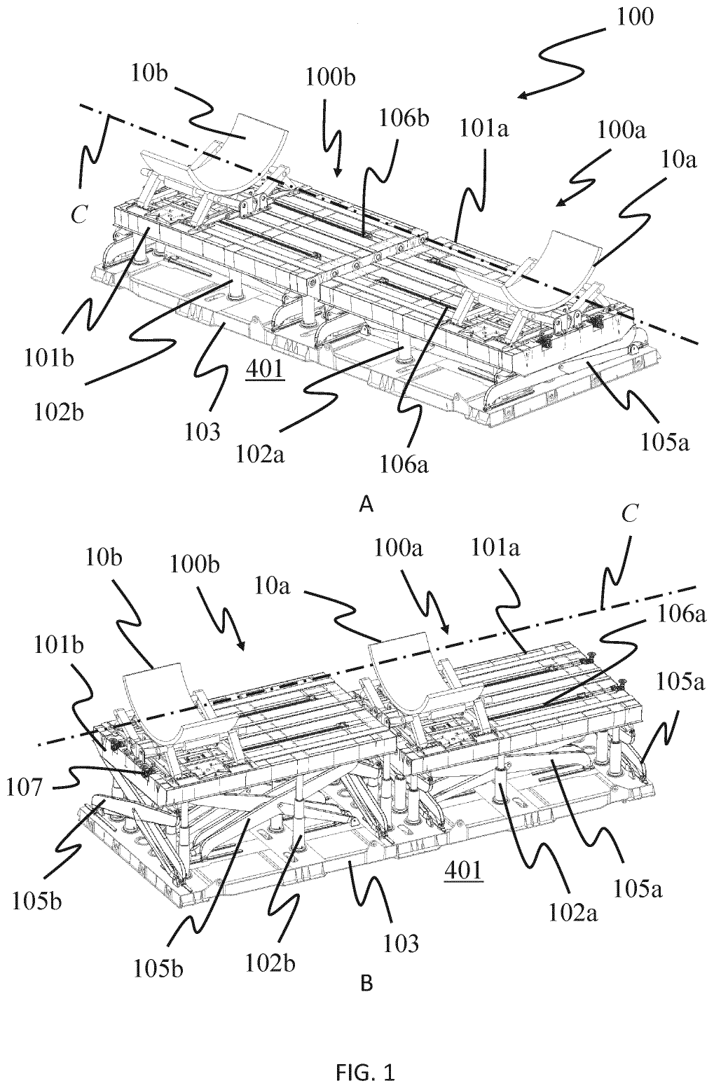

FIG. 1 shows in perspective an inventive pile displacement system 100 in two different angles and arrangements (FIG. 1A and FIG. 1B). The system 100 comprises two subsystems 100a,100b which may be height adjusted independently relative to each other by use of height adjustable devices 102.

Each subsystem 100a, 100b includes a height adjustable support 101a,101b (hereinafter referred to as a first and a second pile table) fixed on top of height adjustment devices 102.

In all illustrated embodiments of the invention, the height adjustment devices are exemplified as hydraulic cylinders 102a,102b. However, other height adjusting devices suitable for lifting pile tables with relevant weights such as linear actuators may be used.

Opposite ends of the height adjustment devices 102 are shown fixed to a pile displacement system base 103 for being supported on a base floor 401. In order to allow support of heavy weights (such as the weight of wind turbine monopiles), the height adjustment devices 102 are accompanied by levelling arms 105,105a,105b coupled with their respective ends to the lower side of the pile tables 101 and the upper side of the pile displacement system base 103. Hence, raising/lowering of the vertical hydraulic cylinders 102 results in a corresponding lifting/lowering of the levelling arms 105.

An additional, or alternative, function of the levelling arms 105 is to keep the pile tables 101 continuously aligned with the pile displacement system base 103, thereto also handling any side forces in horizontal directions.

In the embodiment shown in FIG. 1A and FIG. 1B, the first and second pile tables 101a,101b are rectangular with horizontal center axis mutually aligned in one principal direction C. Further, since the pile tables 101 of FIG. 1A and FIG. 1B are of equal width (i.e. horizontal extent perpendicular to the principal axis C), the pile tables' horizontal boundaries in C are also in alignment with each other.

Each subsystem 100, 100a,100b further includes one or more pile supporting units 10,10a,10b (hereinafter referred to as support cradles) that are movably coupled on top of respective pile tables 101,101a,101b via pile supporting unit guiding tracks 106,106a,106b (hereinafter referred to as support cradle tracks). The support cradles 101 and their respective support cradle tracks 106 are further connected to a support cradle displacement system 107 to allow movement of the support cradles 10 along the principal axis C.

The first subsystem 100a and the second subsystem 100b are in FIG. 1A and FIG. 1B shown in different positions. FIG. 1A shows a situation where the vertical hydraulic cylinders 102a,102b have been retracted fully, thereby positioning the pile tables 101a,101b in a lowermost position.

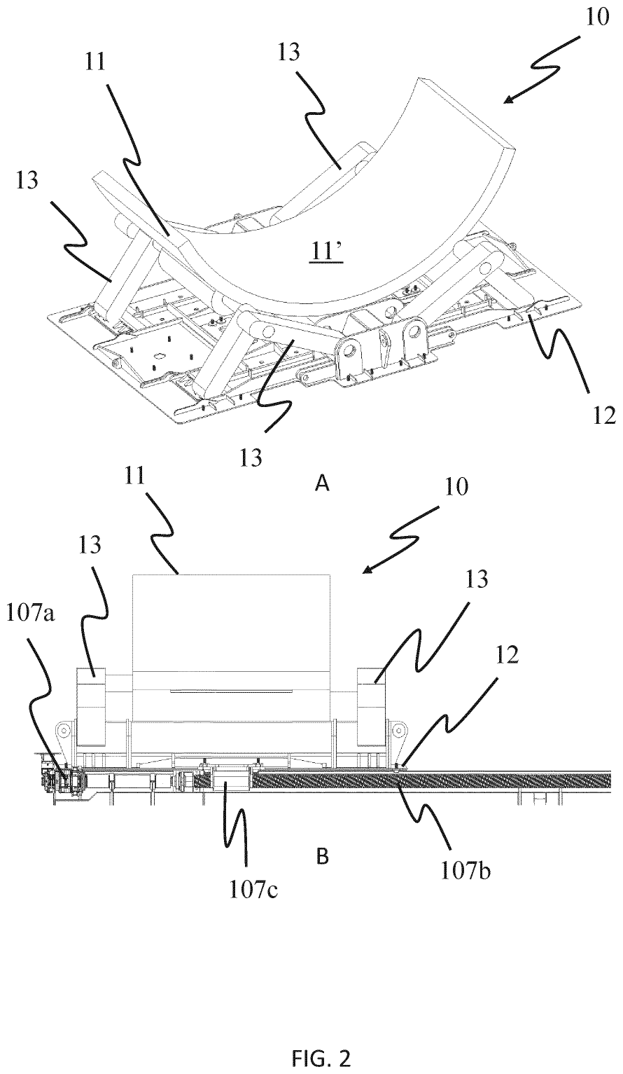

FIG. 2A and FIG. 2B shows a perspective view of a support cradle 10 and a cross sectional view of a support cradle 10 moveably coupled to a support cradle track 106 on a pile table 101 via a displacement system 107, respectively.

The support cradle 10 comprises a concave part 11 with a concave contacting face 11′ adapted to receive a circumferential surface of a horizontal pile 200. The support cradle 10 of FIG. 2A further comprises a support cradle base 12 supported on the above-mentioned pile table 101 and a support cradle framework 13 fixing the concave part 11 to the support cradle base 12. The support cradle framework 13 may be of any design as long as it allows sufficient support of the concave part 11 during operation.

FIG. 2B shows a specific example of a displacement system 107 which includes a motor 107a arranged at at least one end of each support cradle track 106 and a threaded axle 107b being rotatable by use of the motor 107b. Rotation of the axle 107b causes a threaded nut 107c fixed to the lower side of the support cradle base 12 to move along the axle 107b in direction of the principal axis C.

Note that the displacement system 107 illustrated in FIG. 2B may be any system that allows linear movements of the support cradle 10 relative to the corresponding pile table 101. Such linear movements may alternatively or in addition be performed by a human operator and/or another external device such as a crane and/or a winch.

Another example of a displacement system 107 may be a rack-and-pinion system comprises circular gears which couple to corresponding linear gears on the pile table 101.

As for the pile tables 101, the support cradles 10 are mutually oriented such that the horizontal center line of each support cradle 10a,10b are aligned in the principal direction C.

Note that each pile table 101a,10b may comprise more than one support cradle 10a,10b distributed along the pile table's width, for example to allow support and displacement of more than one pile 200 at the same time. A plurality of support cradles 10 along the same track/rail 106 on each pile table 101a,101b may also be envisaged.

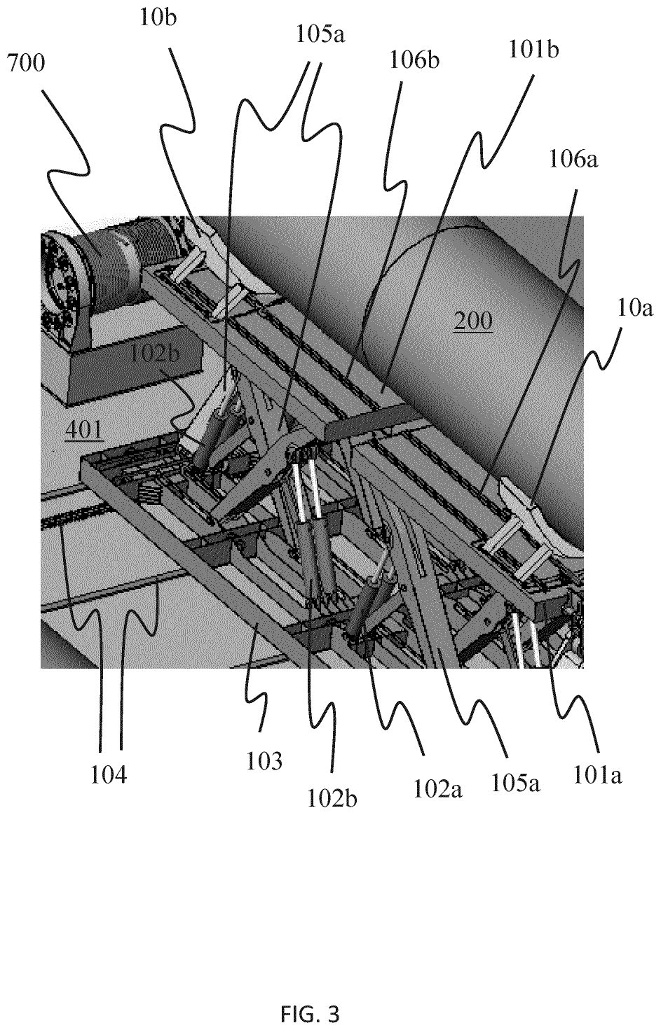

FIG. 3 shows in detail a particular arrangement of the height adjustment devices 102 in form of several cantilevered hydraulic cylinders (in contrast to the vertical hydraulic cylinders in FIG. 1), wherein the pile tables 101 are set in a raised position (i.e. extended hydraulic cylinders). A pile 200 is shown arranged on top of the second support cradle 10b on the second pile table 101b near an up-ending winch 700 (see below). In this particular embodiment, a total of eight hydraulic cylinders 102a,102b are used for each pile table 101a,101b. The coupling system 102,105 connecting the pile tables 101 with the pile displacement base 103 further includes leveling arms 105,105a,105b to increase stability and weight capability. The leveling arms 105 have one upper end pivotably connected to the underside of the respective pile table 101 and a lower end movably connected in the horizontal plane to the upper side of the pile displacement base 103.

The upper and lower ends of the hydraulic cylinders 102 may in one exemplary embodiment connected to an upper part of the leveling arms 105 and the upper side of the pile displacement base 103, respectively.

In another exemplary embodiment (as shown in FIG. 1) the hydraulic cylinders 102 are directly connected to the pile tables 101.

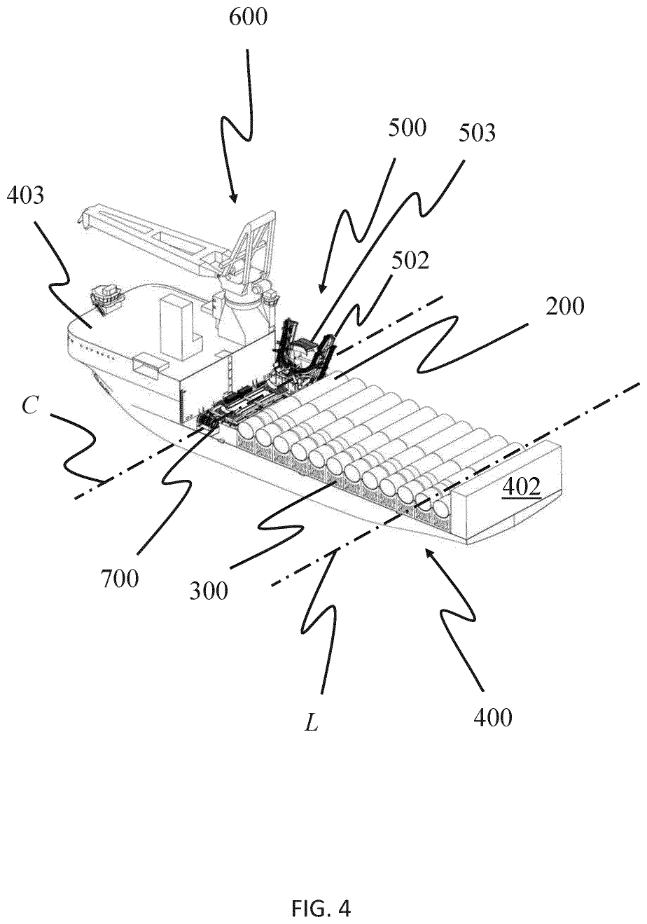

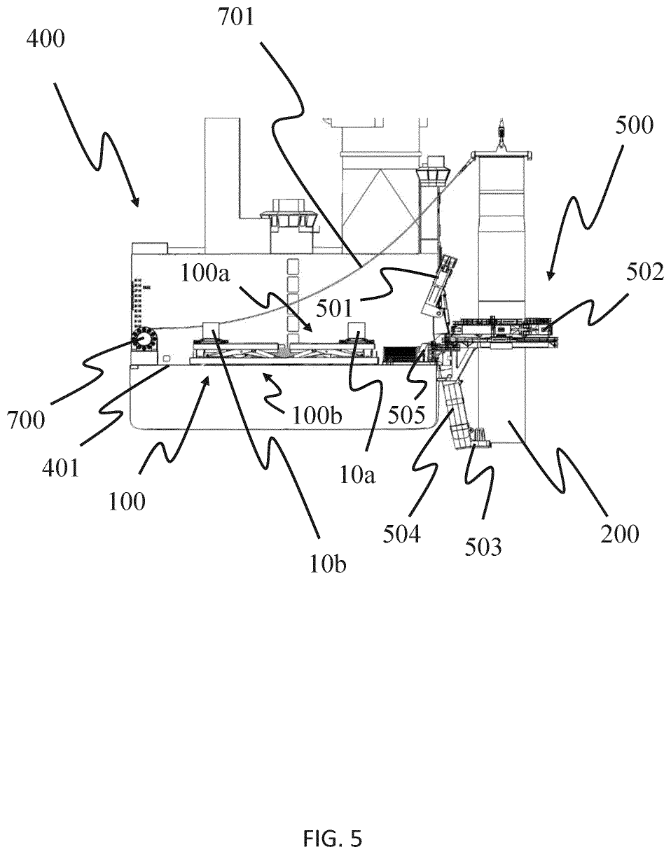

FIGS. 4 and 5 show the above described pile displacement system 100 arranged on a deck 401 of a transport vessel 400 with its principal direction C arranged transverse of the vessel's deck 401, i.e. perpendicular to an aft 402-to-bow 403 direction of the vessel 400. The vessel 400 is designed to transport a plurality of horizontal monopiles 200 for offshore wind turbines, oriented with their longitudinal axes L all parallel to C. Each of the plurality of piles 200 are placed in a dedicated pile parking support 300 shown as pairs of parking cradles located at both sides of the deck boundaries 401′ along the vessel's aft-to-bow direction. The pile parking supports 300 raise the height of the piles 200 a distance from the deck 401.

A pile up-ending tool 500 pivotable with a rotational axis along the aft-to-bow direction of the vessel 400 is arranged at at least one of the deck boundaries 401′.

FIG. 5 shows a cross sectional view along the aft-to-bow direction of a pile 200 after having been rotated by use of the pile up-ending tool 500 from a horizontal to a vertical orientation relative to the vessel's deck 401. The pile up-ending tool 500 comprises in this exemplary configuration a pivot arm 504, an upper support 501 pivotably connected to one upper end of the pivot arm 504 for providing support in a radial direction of the pile 200, an end support 503 connected to an opposite, lower end of the pivot arm 504 for supporting at least part of the pile's weight when in vertical orientation and a pivotable pile gripper 502 arranged between the upper support 501 and the end support 503, configured to releasably grip the pile's radial circumference in order to ensure horizontal stability. The pivoting of the pile up-ending tool 500 is ensured by a pivoting mechanism 505 fixed to the deck boundary 401′ and pivotably coupled to the pivot arm 504.

The up-ending of the pile 200, when arranged in the pile up-ending tool 500, may be achieved by a crane 600 fixed with a crane wire to an upper end of the pile 200.

Additional control of the up-ending movement may be ensured by a winch 700 installed on the deck 401 at the deck boundary 401′ opposite of the pile up-ending tool 500 (FIG. 5). A winch cable 701 is in this exemplary configuration connected to the upper end of the pile 200, allowing continuous adjustment of a tension force towards the deck 401 to avoid uncontrolled rotation away from the vessel 400 during the up-ending.

Further, the pile up-ending tool's center axis running through the upper support 501 and the end support 503, and projected to the horizontal plane, is oriented at all time parallel to the principal direction C of the pile displacement system 100.

One specific purpose of this invention is to provide a method and a system for allowing controlled displacement of a horizontal pile 200 from a parking position on the pair of parking cradles 300 to a position within the pile up-ending tool 500 to allow the up-ending movement from horizontal to vertical to commence.

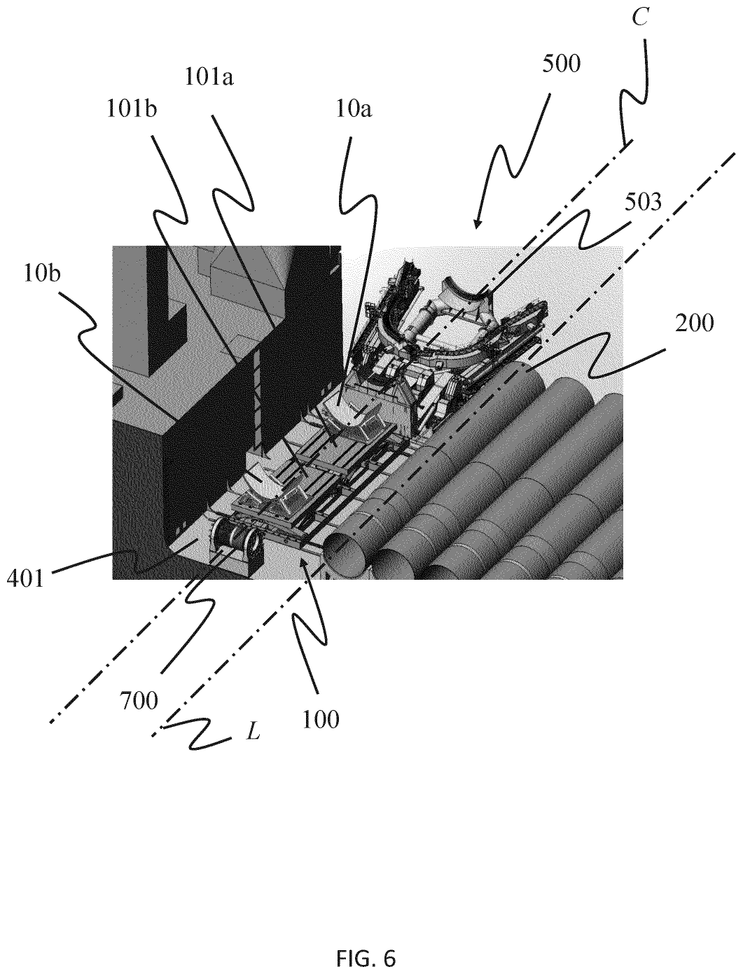

Note that ‘horizontal’ is herein defined as the orientation parallel to the deck 401. The different steps in the pile displacement process are illustrated through FIGS. 6 to 18.

FIG. 6 shows the pile up-ending tool 500 arranged in a pile receiving position in which both the pivot arm 504 and the upper support 501 have been pivoted to an end point towards the deck 401 (i.e. counterclockwise in FIG. 6 since the tool 500 is placed at the starboard deck boundary 401′). As a result, the upper support 501 and the end support 503 are mutually aligned in a horizontal plane, or near horizontal plane. In this pile receiving position, arms of the pile gripper 502 are in fully open positions.

In the initial position shown in FIG. 6, the rectangular pile displacement system 100 (as shown in detail in FIG. 1) is arranged on the deck 401 with its longitudinal axis along the principal direction C (i.e. perpendicular to the aft-to-bow direction of the vessel 400), directly behind the pile up-ending tool 500. Further, a plurality of horizontal piles 200 are arranged next to the pile displacement system 100/pile up-ending tool 500 with longitudinal axes L parallel to the principal direction C; all parked in their respective pair of parking cradles 300.

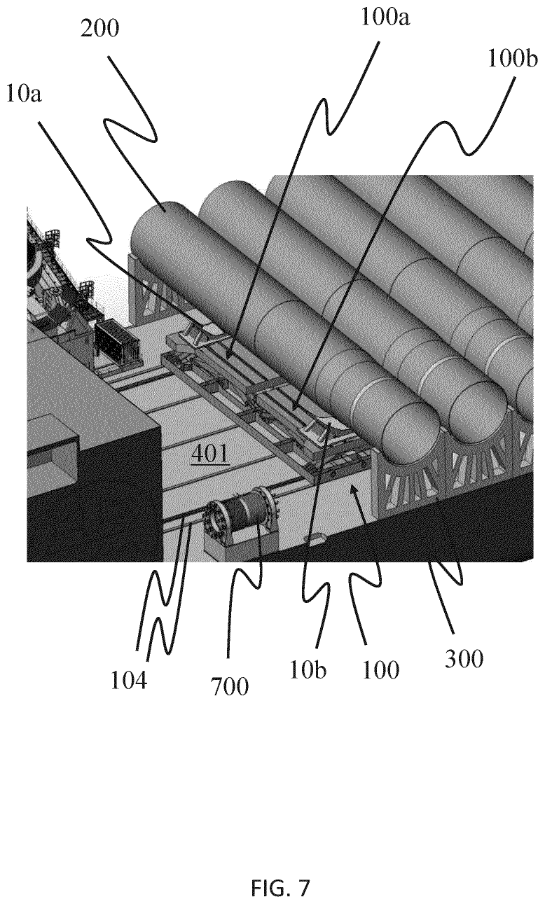

FIG. 7 shows a second step of the pile displacement process where the pile tables 101a,101b have been lowered towards the deck 401 such that the highest point of the pile displacement system 100 is lower than the lowest point of the nearest parked pile 200. Further, due to deck tracks/rails 104 oriented in the aft-to-bow direction along the deck 401, and corresponding recesses/protrusions on or at the deck contacting surface of the pile displacement system base 103, the pile displacement system 100 is allowed to move sideways (i.e. along the aft-to-bow direction, perpendicular to the principal direction C) to a position where the support cradles 10 on both pile tables 101 are aligned directly below the pile 200. In FIG. 7, the pile displacement system 100 is seen to have been moved sideways to such a position.

One example of mechanisms to ensure sideways movements can be a rack-and-pinion where at least some of the rails 104 are linear gears coupled to circular gears. As indicated above, an identical or similar linear movement mechanism may also be used for the movement of the support cradles 10a,10b on the respective pile tables 101a,101b. However, any system resulting in a linear sideways movement of the pile displacement system 100 and/or longitudinal movements of the support cradles 10a,10b may be envisaged.

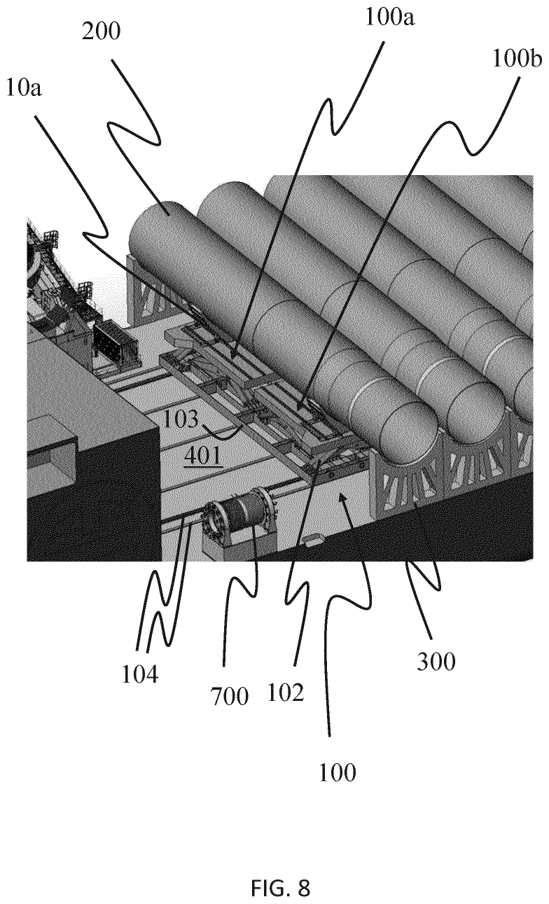

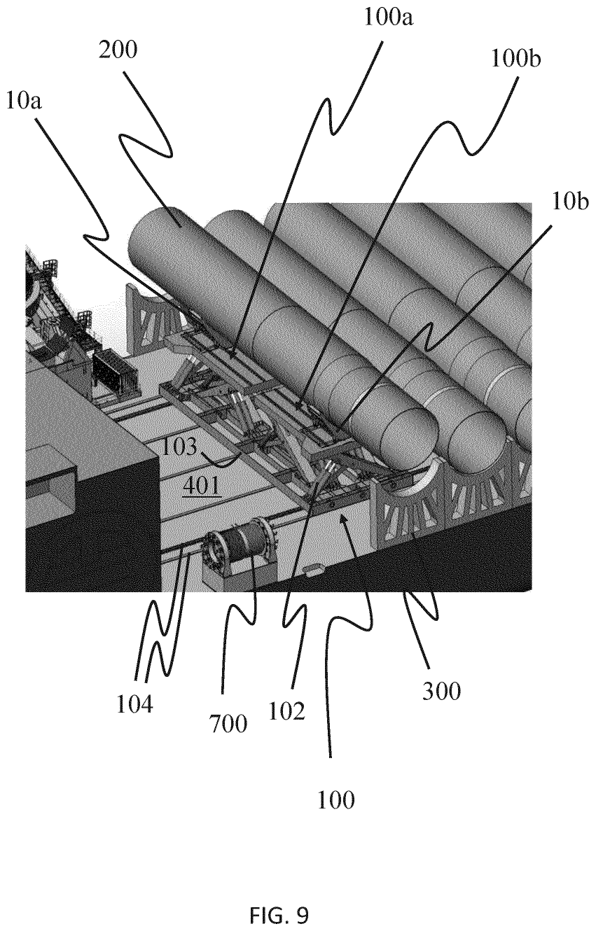

FIGS. 8 and 9 show third and fourth steps of the pile displacement process where both pile tables 101 are raised by activating the hydraulic cylinders 102 to firstly achieve contact between the support cradles 10 and the underside of the pile 200 (FIG. 8) and secondly (after any additional horizontal alignments of the pile displacement system 100 and/or support cradles 10) further raising the pile tables 101 until the height of the pile 200 is higher than the highest point of the respective pair of parking cradles 300 (FIG. 9).

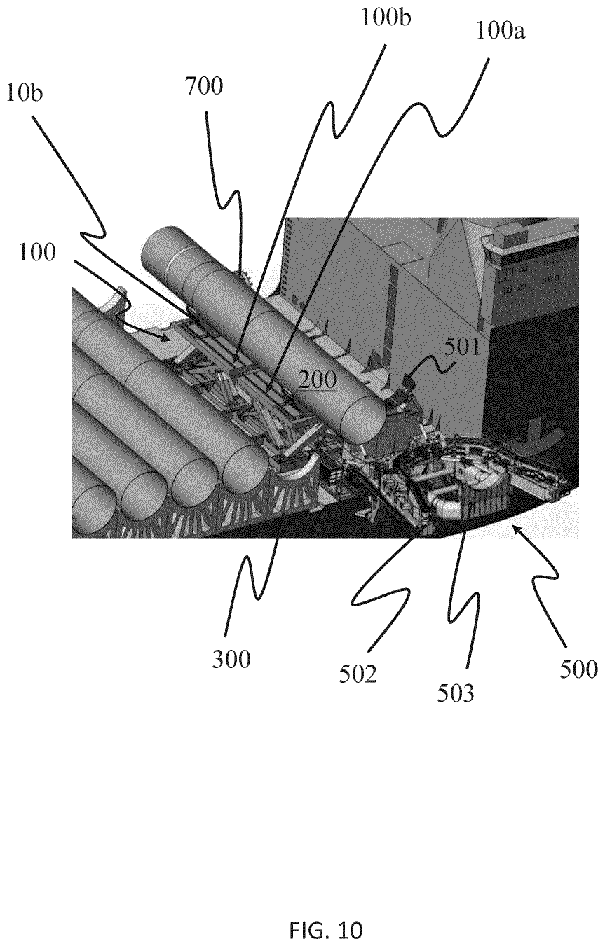

As shown in the fifth step in FIG. 10, the pile displacement system 100, with the pile 200 arranged thereon, may now move sideways back towards the initial position without the risk of undesired impacts with the parking cradle 300.

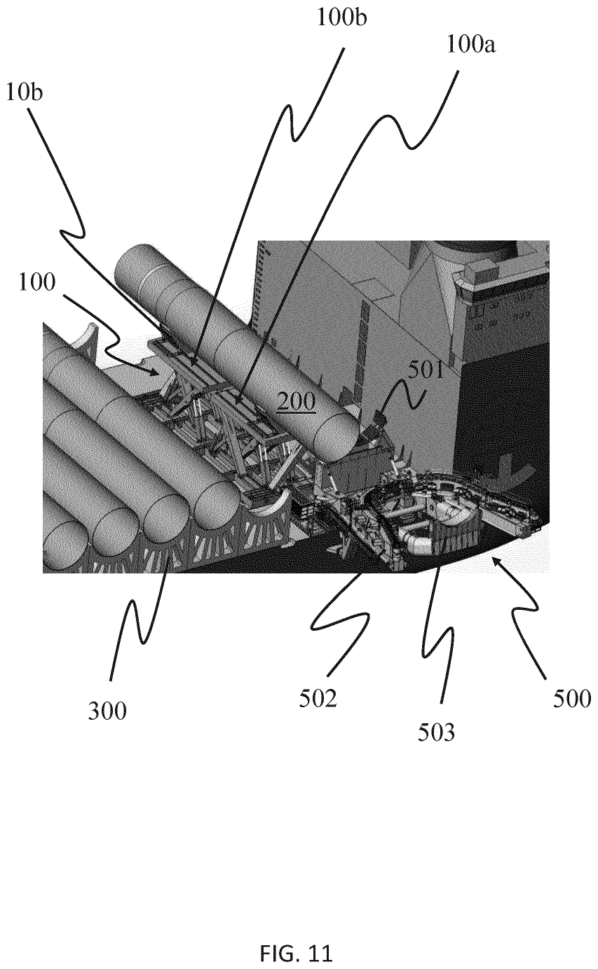

When the pile 200 has reached a position adjacent (i.e. side-by-side) the pile up-ending tool 500, the height may (if necessary) be further adjusted in a sixth step (FIG. 11) to a height where the lowest position of the pile 200 is higher than the highest position of the pile up-ending tool 500, in order to avoid risk of undesired impact with the tool 500. The latter height adjustment may also be performed during the fifth step.

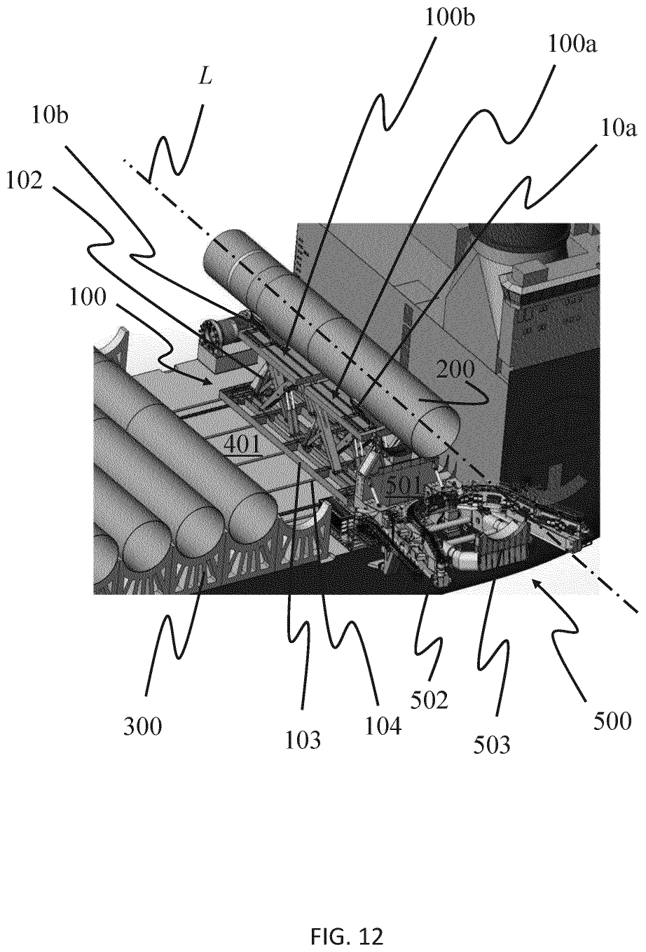

In FIG. 12, a seventh step has been completed where the pile displacement system 100 (with the pile 200) has moved further sideways until the horizontal longitudinal axis L of the pile 200 is aligned with the common horizontal center axis C of the upper support 501 and the end support 503.

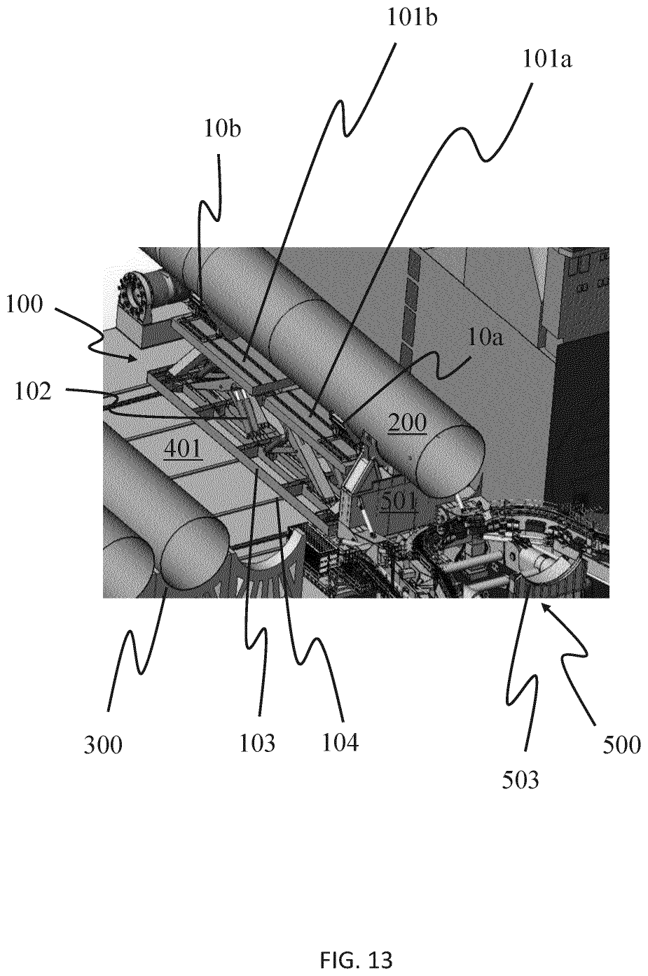

The pile tables 101 can now in an eighth step (FIG. 13) be lowered until contact is reached between the underside face of the pile 200 and a receiving support face of the upper support 501, thereby distributing the total weight of the pile 200 between the first subsystem 101a, the second subsystem 100b and the upper support 501.

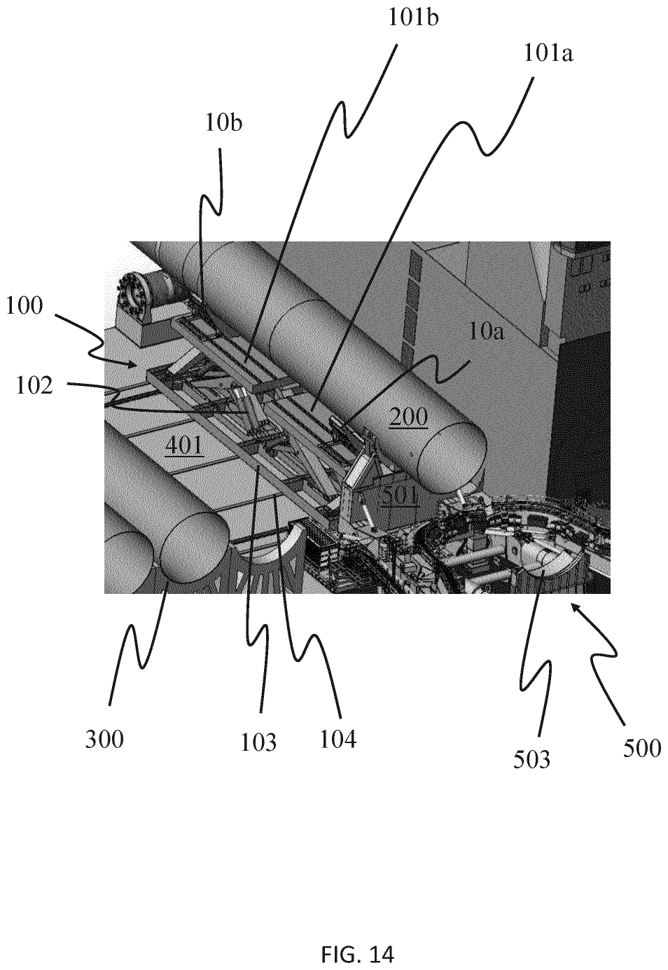

In a ninth step (FIG. 14), the first pile table 101a nearest the pile up-ending tool 500 is further lowered towards the deck 401, causing the weight of the pile 200 taken up by the first pile table 101a to be transferred in full to the upper support 501 and the second pile table 101b. The first support cradle 10a arranged on top of the first pile table 101a is as a result released from its contact with the pile 200.

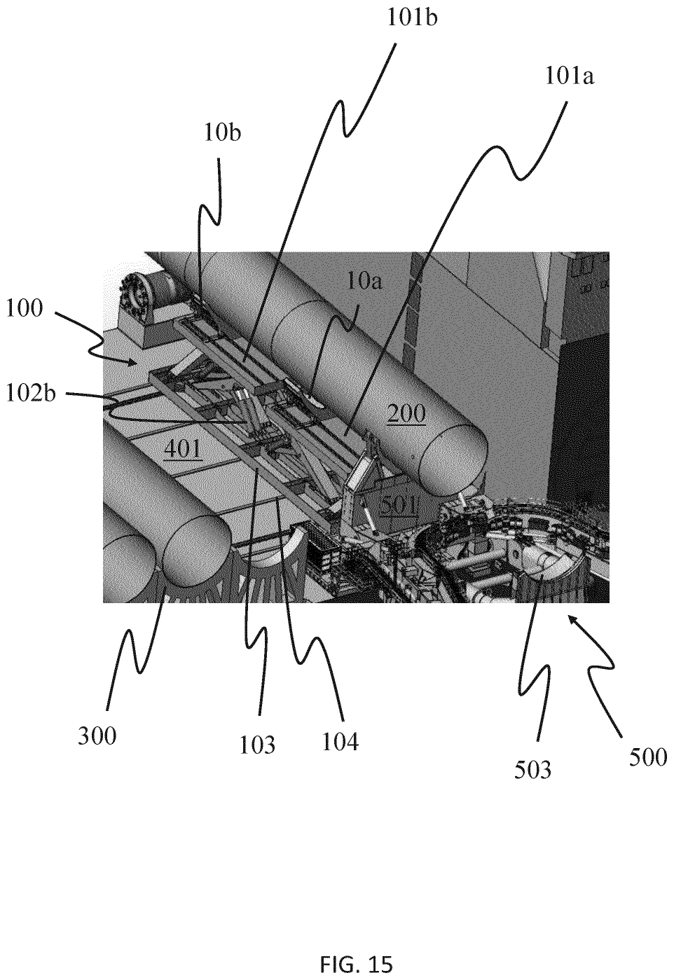

In a tenth step of the pile displacement process (FIG. 15) the now released first support cradle 10a is moved a distance along the pile's longitudinal axis L (i.a. along axis C) a distance along the first pile table 101a away from the upper support 501/the support 503, preferably a distance at least 80% of the pile table's 101a entire length, for example 90%.

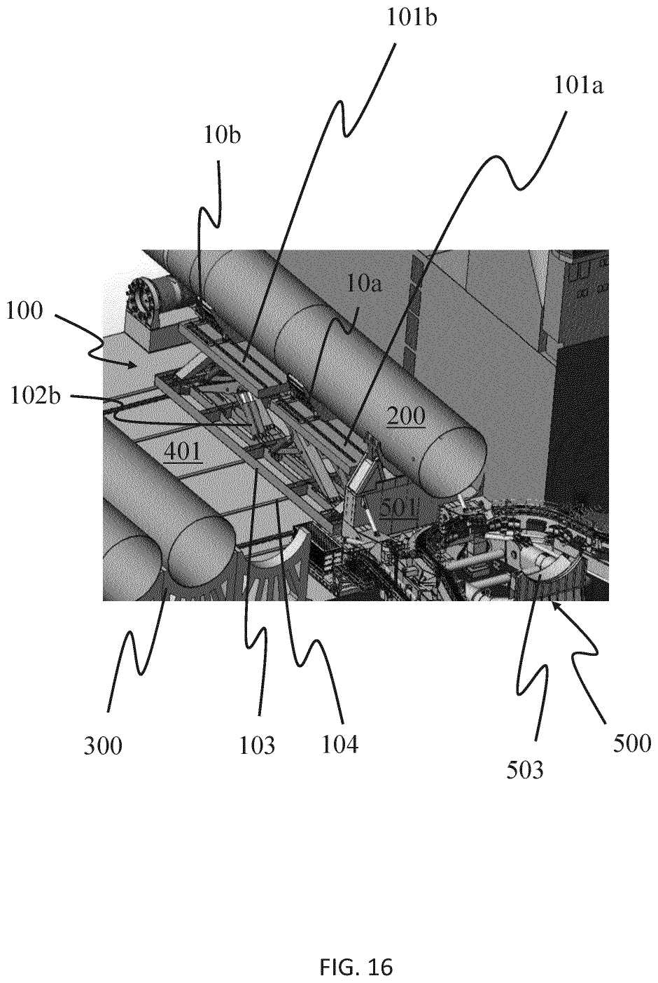

In an eleventh step (FIG. 16), the first pile table 10a is raised until the weight of the pile 200 is again released from the upper support 501 and is distributed entirely between the first and second subsystems 100a,100b.

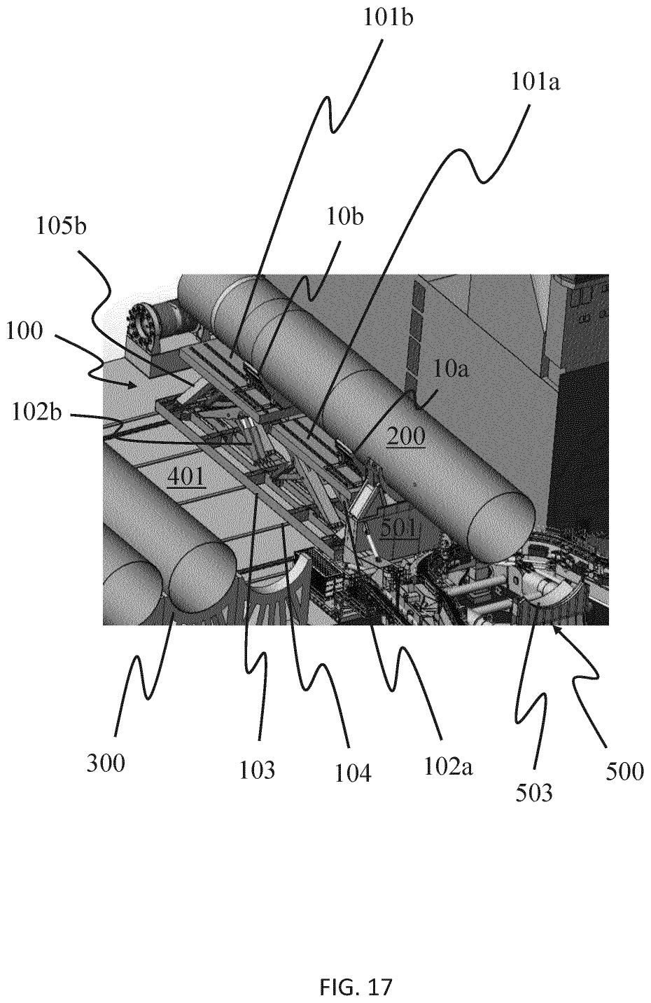

The final, twelfth step (FIG. 17) can now thus be performed where both the first and the second support cradle 10a,10b are moved simultaneously a distance, for example 90% of the pile tables' entire length, towards the pile up-ending tool 500, thereby moving the entire pile 200 towards the end support 503.

The ninth to the twelfth steps are then repeated until contact, or near contact, is established with the receiving face of the end support 503.

The up-ending process of the pile 200 from horizontal to vertical orientation may hence commence.

In the preceding description, various aspects of the pile displacement system and the method for displacing a pile by use of the pile displacement system have been described with reference to the illustrative embodiment. For purposes of explanation, specific numbers, systems and configurations were set forth in order to provide a thorough understanding of the inventive system and its workings. However, this description is not intended to be construed in a limiting sense.

Various modifications and variations of the illustrative embodiment, as well as other embodiments of the system, which are apparent to persons skilled in the art to which the disclosed subject matter pertains, are deemed to lie within the scope of the present invention.

### REFERENCE NUMERALS

| | |
|---|---|
| 10 | Pile support unit/support cradle |
| 10a | First pile support unit/first support cradle |
| 10b | Second pile support unit/second support cradle |
| 11 | Concave part of support cradle |
| 11′ | Contacting face of concave part |
| 12 | Support cradle base |
| 13 | Support cradle framework |
| 100 | Pile displacement system |
| 100a | First subsystem |
| 100b | Second subsystem |
| 101 | Height adjustable support/pile table |
| 101a | First height adjustable support/first pile table |
| 101b | Second height adjustable support/second pile table |
| 102 | Height adjustment device/hydraulic cylinders |
| 102a | Height adjustment device for first height adjustable support |
| 102b | Height adjustment device for second height adjustable support |
| 103 | Pile displacement system base/ |
| 104 | Base floor tracks/deck rails |
| 105 | Levelling arm |
| 105a | Levelling arm of the first subsystem |
| 105b | Levelling arm of the second subsystem |
| 106 | Pile supporting unit guiding track/support cradle track |
| 106a | Support cradle track of first subsystem |
| 106b | Support cradle track of first subsystem |
| 107 | Support cradle displacement system |
| 107a | Motor |
| 107b | Threaded axle |
| 107c | Threaded nut |
| 300 | Pile parking support/pair of parking cradles |
| 400 | Transport vessel |
| 401 | Deck |
| 401′ | Deck boundary |
| 402 | Aft |
| 403 | Bow |
| 500 | Up-ending tool |
| 501 | Upper support |
| 502 | Pile gripper |
| 503 | End support |
| 504 | Pivot arm |
| 505 | Pivot mechanism |
| 600 | Crane |
| 700 | Up-ending winch |
| 701 | Winch cable |
| L | Longitudinal axis of pile |
| C | Principal direction of pile displacement system |

1. A method for displacing a horizontally oriented monopile for an off-shore wind turbine parallel to a base floor by use of a pile displacement system comprising:
a first subsystem, and
a second subsystem arranged adjacent to the first subsystem along a longitudinal axis of the monopile,
wherein each of the first and the second subsystems comprises:
a height adjustable support, and
a pile support unit arranged on the height adjustable support such that the pile support unit is movable along the monopile's longitudinal axis,
wherein the method comprises:
A. arranging the monopile onto the monopile support units of the first and second subsystems,
B. lowering the height adjustable support of at least the first subsystem towards the base floor until the weight of the monopile is transferred from at least the first subsystem to an external support structure aligned along the monopile's longitudinal axis, adjacent to the first subsystem,
C. moving the pile support unit of the first subsystem a distance in direction away from the external support structure,
D. raising the height adjustable support of the first subsystem away from the base floor until the weight of the monopile is transferred from the external support structure to the first subsystem, and
E. moving the pile support units of the first and the second subsystems a distance in direction towards the external support structure.

2. The method in accordance with claim 1, wherein the method further comprises:
moving the pile displacement system sideways along the base floor in direction perpendicular to the monopile's longitudinal axis.

3. The method in accordance with claim 2, wherein, prior to step A, the method further comprises:
lowering the height adjustable supports towards the base floor such that the highest point of the pile displacement system is lower than a minimum vertical distance from the base floor to the horizontal monopile stored on the base floor within a pile parking support,
moving the pile displacement system sideways along the base floor towards the horizontal monopile, and
aligning the pile displacement system with the monopile's longitudinal axis such that the pile supporting units are located directly below the monopile.

4. The method in accordance with claim 3, wherein the method further comprises:
raising the height adjustable supports until step A is completed, and
continue raising the height adjustable supports until the lowest point of the pile relative to the base floor is higher than the highest point of the pile parking support.

5. The method in accordance with claim 4, wherein, between step A and step B, the method further comprises:
moving the pile displacement system with the monopile sideways towards the external support structure, and,
if needed, raising the height adjustable supports until the lowest point of the monopile relative to the base floor is higher than the highest point of the external support structure.

6. The method in accordance with claim 1, wherein, between step A and step B, the method further comprises:
moving the pile displacement system sideways until the monopile's longitudinal axis is aligned with a vertical center plane of the external support structure.

7. The method in accordance with claim 1, wherein
the base floor is a deck constituting part of a vessel suitable for transporting a plurality of wind turbine monopiles between a port and an installation site, and
the external support structure constitutes part of a pile upending tool configured to tilt one of the plurality of monopiles between:
a horizontal orientation parallel to the deck and located at least partly within the deck boundaries, and
a vertical orientation outside the deck boundaries.

8. The method in accordance with claim 7, wherein the pile upending tool further comprises:
an end support at an equal vertical height as the external support structure and arranged such that the external support structure and the end support are aligned along the monopile's longitudinal axis, and
wherein steps B to E are repeated until a pile end of the monopile located nearest the pile upending tool abuts the end support.

9. A non-transitory computer-readable medium having stored thereon a computer program comprising instructions to execute a method for displacing a horizontally oriented monopile for an off-shore wind turbine parallel to a base floor by use of a pile displacement system comprising:
a first subsystem, and
a second subsystem arranged adjacent to the first subsystem along a longitudinal axis of the monopile,
wherein each of the first and the second subsystems comprises:
a height adjustable support, and
a pile support unit arranged on the height adjustable support such that the pile support unit is movable along the monopile's longitudinal axis,
wherein the method comprises:
A. arranging the monopile onto the monopile support units of the first and second subsystems,
B. lowering the height adjustable support of at least the first subsystem towards the base floor until the weight of the monopile is transferred from at least the first subsystem to an external support structure aligned along the monopile's longitudinal axis, adjacent to the first subsystem,
C. moving the pile support unit of the first subsystem a distance in direction away from the external support structure,
D. raising the height adjustable support of the first subsystem away from the base floor until the weight of the monopile is transferred from the external support structure to the first subsystem, and
E. moving the pile support units of the first and the second subsystems a distance in direction towards the external support structure.

10. A pile displacement system for displacing a monopile for an off-shore wind turbine towards an upper support of an upending tool aligned along a principal direction, transverse of a vessel's deck, wherein the pile displacement system comprises:
a first subsystem and a second subsystem arranged adjacent to each other along the principal direction,
wherein each of the first and the second subsystems comprises:
a height adjustable support, and
a pile support unit arranged on movably coupled on top of the height adjustable support such that the pile support unit is movable along the principal direction, and
wherein the pile support unit of the first subsystem is aligned with the pile support unit of the second subsystem and the upper support.

11. The pile displacement system in accordance with claim 10, wherein each pile support unit comprises a concave pile receiving face.

12. The pile displacement system in accordance with claim 11, wherein the concave pile receiving face has a radius of curvature equal or near equal to a radius of curvature of the monopile to be displaced.

13. The pile displacement system in accordance with claim 10, wherein each of the first and the second subsystems comprises height adjusting means for adjusting the height of the height adjustable support relative to a base floor during use.

14. The pile displacement system in accordance with claim 13, wherein the pile displacement system further comprises:
a pile displacement system base onto which the height adjustable supports of the first and second subsystems are connected via the height adjusting means.

15. The pile displacement system in accordance with claim 14, wherein the pile displacement system base is configured movable along a base floor onto which the pile displacement system base is supported during use, in direction perpendicular to the principal direction.

16. The pile displacement system in accordance with claim 14, wherein the side of the pile displacement system base facing towards the base floor during use comprises at least one of a recess and a protrusion for allowing movement on one or more base floor tracks oriented perpendicular to the principal direction on or within the base floor.

17. The pile displacement system claim 10, wherein
each height adjustable support comprises a pile supporting unit guiding track oriented in the principal direction, and
each pile supporting unit comprises at least one of a recess and a protrusion for allowing movement along the pile supporting unit guiding tracks.
